(19) United States
(12) Patent Application Publication
(10) Pub. No.: US 2012/0203536 A1
(43) Pub. Date: Aug. 9, 2012

(54) METHOD AND SYSTEM FOR SOFTWARE BEHAVIOUR MANAGEMENT

(75) Inventors: Rosario Gangemi, Rome (IT); Vincenzo Sciacca, Rome (IT); Massimo Villani, Rome (IT)

(73) Assignee: INTERNATIONAL BUSINESS MACHINES CORPORATION, Armonk, NY (US)

(21) Appl. No.: 13/502,792

(22) PCT Filed: Aug. 31, 2010
(86) PCT No.: PCT/EP2010/062767

§ 371 Date: Apr. 19, 2012

(30) Foreign Application Priority Data
Oct. 21, 2009 (EP) 09173684.3

(51) Int. Cl. G06F 9/45; G06F 9/455

(52) U.S. Cl. 703/22

(57) ABSTRACT

A performance or reliability model representing the behaviour of an application under different system resource conditions is provided. This model may take the form of one or more sparse matrix providing a reliability or performance values for different combinations of conditions. This model is distributed to a user of the application, and is consulted during execution of the application with reference to system resource information provided by the operating system or other monitoring software so as to provide an indication of the expected performance of the application under present operating conditions. This indication may be notified to a user, for example in a case where the indication falls outside predetermined bounds of satisfactory operation. The system may also attempt to renegotiate attributed system resources to as to improve performance.

### FIELD OF THE INVENTION

The present invention relates to a method and system for managing the behaviour of software as a function of the resources available to that piece of software. Background of the invention The prediction of the exact behavior of an application in customer production environments from the results of functional test (FVT) cases identified in the design phase is extremely challenging, even if these are integrated with additional tests (capacity planning, system test) commonly adopted in software development laboratories. Most likely such test cases identify meaningful tests from the functional point of view but they are executed in operating conditions that are unlikely to match the exact customer execution environment in the production phase.

A widely used approach for large applications to address this problem is so called “capacity planning” or “performance load” testing, in which some specific (example precise hardware resources requirements) and relevant (example reliability) aspects of the applications are tested in different scenarios. In such scenarios the operating environment differs among “ideal” test cases because of the unpredictable amount of computing resources made available to the software application during production at customer site: in real conditions the application is often deployed in large clustered data centers and its scheduling happens together with other concurrent applications, such that dramatic variations in available resources can occur. These are some of the reasons the computing resources available to the application are variable from an ideal stand alone or simulated testing. It is desirable for “capacity planning” to provide more accurate in predictions than is currently possible: the current best practise is that the result of the capacity planning phase is a definition of the hardware requirements necessary for the application to operate correctly in the worst conditions. In other words, “performance load” or “capacity planning” tools are usually provide a measure of the operating resource needed to run properly, i.e. From a functional point of view in the “worst case”.

U.S. Pat. No. 5,655,074 describes a software tool for systems engineering of large software systems. The process begins with the step of gathering data on observations of a large number of characteristics about a software system (including historical and planned system adjustments) for each uniquely identifiable software component. Also gathered are historical data regarding faults or problems with each software component. The fault data is statistically mapped to measured characteristics of the software to establish a risk index. The risk index can be used as a predictive tool establishing which characteristics of the software are predictive of the software's performance or, alternatively, the risk index may be used to rank order the components to determine which components need less testing in a effort to save resources.

### SUMMARY OF THE INVENTION

As discussed, prior art testing techniques concentrate on identifying minimum system requirement is a static manner. It is an aim of the present invention to provide information about the expected performance of an application, dynamically, when the application is executed in the client environment.

According to the present invention there is provided a method of optimising software execution according to the appended independent claim 1, an apparatus according to the appended claim 12, a computer program according to the appended claim 13, a performance model according to the appended claim 14 and a computer readable medium according to the appended claim 15. Further preferred embodiments are defined in the dependent claims.

Advantages of the present invention will become clear to the skilled person upon examination of the drawings and detailed description. It is intended that any additional advantages be incorporating therein.

### BRIEF DESCRIPTION OF THE DRAWINGS

Embodiments of the present invention will now be described by way of example with reference to the accompanying drawings in which like references denote similar elements, and in which:

FIG. 1 shows the steps of a first embodiment of the present invention;

FIG. 2 shows an example of performance model in the form of a multi-dimensional space 200;

FIG. 3 Shows a further example of performance model in the form of a multi-dimensional space 300;

FIG. 4 shows the steps of a second embodiment of the present invention;

FIG. 5 shows the steps of a third embodiment of the present invention; and

FIG. 6 shows a computer environment suitable for implementing certain embodiments.

### DETAILED DESCRIPTION OF THE PREFERRED EMBODIMENT

It is proposed to construct (design, implementation and assembly) and deploy an application to an operating environment in association with a performance model. The performance model can be realized leveraging application testing procedures with additional measures that focus on the resources made available by the execution environment in a manner that is preferably agnostic with respect to a particular scope of the application so that it can be applied to the largest possible number of applications.

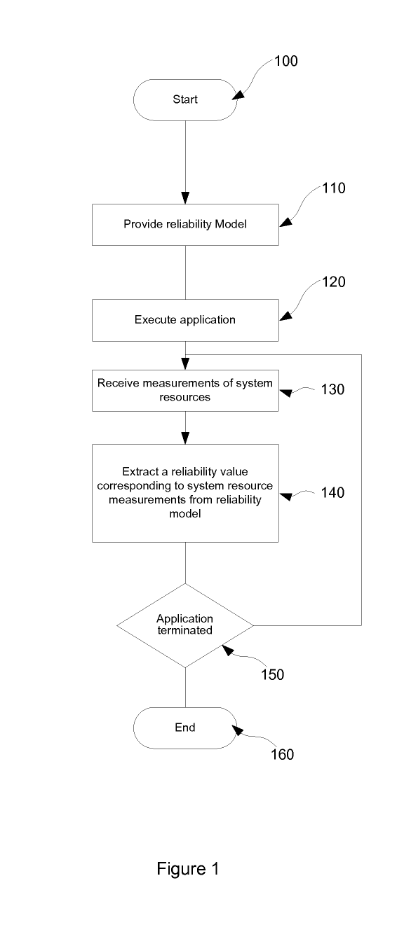

FIG. 1 shows the steps of a first embodiment of the present invention. As shown, the process starts at step 100, and proceeds to step 110 at which a performance model for example as described in further detail hereafter is provided. At step 120 the application to which the performance model relates is executed, and at step 130 measurements the system resources used to define the model are received, for example from the operating system or other monitoring software or hardware. At step 140 the measurements are used to extract a performance value from the performance model corresponding to said measurements. At step 150 it is determined whether the application has terminated, in which case the process terminates at step 160, or otherwise the process returns to step 130, so that the process continues to monitor the performance level of the software as a function of monitored system resource availability for as long as the application is operational. Accordingly, there is provided a method of optimising software execution in a system in which said software is executed, comprising the steps of providing a performance model representing the performance of said software under different system conditions as described in terms of one or more predetermined system resources, receiving a measurement of each of predetermined system resources for a given moment in time and extracting a performance value from said performance model corresponding to said measurements. The expression performance as used throughout the present disclosure may reflect any desired behaviour of a software application. According to a preferred embodiment the performance criterion in question is the reliability of the software.

Taking by way of example an Application Server such as WebSphere Application Server, Tomcat, JBoss etc as the operating environment and a J2EE application as the application, the resources (cpu, memory, disk space, virtual memory etc. . . . ) would be identified, and formally defined, since a resource could be also logically and indirectly related to an hardware resource for example such as those that the Application Server makes available to J2EE Applications and those that can be programmatically made available to them.

A fixed available set of computing resources (example 1 GB RAM, 100 GB disk space, 400 sockets etc. . . . ) can be seen as an application operating point in a NR-dimensional space where NR is the number of the selected computing resources (a subset or the entire set of computing resources defined in a hosting environment) that are relevant to performance measures.

The “performance model” is computed according to each of functional test case of the application such that it will allow for each application operating point provisioning of a numeric formal measure (comparable to other releases of the same software or other deployment of the same software) of the application performance: how this is obtained is explained in details in the implementation section.

The artifact that expresses the performance model information may be one or more matrices, more often a sparse matrix, where each of the axes will be associated to one computing resource used for the computation of the performance and each cell will express after normalization the probability that a “problem”, e.g. crashes, misses of quality of service, exceptions, time-out etc. arises. Each such “problem” is preferably formally defined as a condition, in terms for examoke of a match of a word in a log file, a Boolean expression on a CIM information model and so on.

According to certain embodiments, the performance model may comprise a set of NM different matrices each related to a specific defined problem or even different according to additional criteria, for example relating to the same “problem” definition but for a different platform.

According to certain embodiments the performance model is populated by testing the software. This testing of the software may comprise repeatedly executing the software in systems configured with each of the desired combinations of system resources, and compiling statistical data concerning the behaviour occurring under that configuration. One example of a system resource that might be thus tested is system memory, and the occurrence of a system or application crash may be used as the formal measure used as the basis of the statistical data, as determined for example using log monitoring software that listens to the windows events log. It is possible to test a single test case in many memory conditions to classify the software program's memory consumption “personality” or non-functional “aspect” profile with respect to computing resource utilization, in this example memory but the same approach can be applied to sockets, cpu units etc and so on. It may be expected that test cases will tend to fail when the available memory decreases beyond a certain level, which in real environments may occur simply because other applications are consuming it.

Advantageously the repetitions of tests can be carried out with recourse to an operating/execution environment that allows the configuration of its computing resources via a programmatic interface. An example could be a virtual machine, which may be sequentially restarted with different resource parameters. In such an environment it is a simple matter to redefine the memory, the number of processors or the number of available sockets etc. depending on the parameter to be tested. The overall results from the many tests execution can be used for the estimation of the average probability of failure, for example in terms of a number of bad executed test cases over the total and/or its variance of occurrence.

If a test condition is identified by a point in a multi-dimensional space where each axis is a computing resource. At the end for each test condition a probability density distribution (pdf) can be estimated and associated to each point with average and variance parameter values. When the number of test cases repetitions is over a threshold (the threshold itself that can be computed using significance tests analysis), for example 1000 a normal (gaussian) pdf can be assumed. The estimated average mean and variance can be applied at runtime for dynamic estimation of the probability to have an application failure of the same application just from the current operating conditions from the available computing resource.

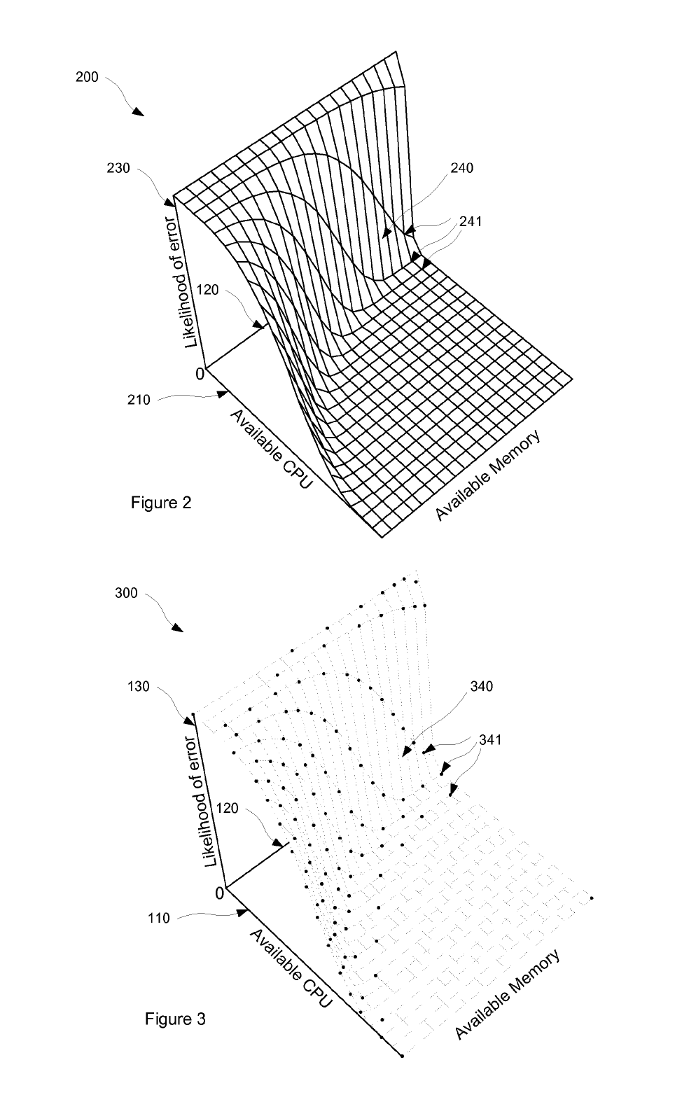

FIG. 2 shows an example of performance model in the form of a multi-dimensional space 200. Specifically as shown the X axis 210 and Y axis 220 correspond to Available CPU and Available memory, with the origin in the bottom left. The z Axis 230 meanwhile represents the likelihood of error. The likelihood of error is preferably normalized so as to give a likelihood of error under standard condition, where the likelihood of error may represent the percentage chance of an error occurring in a predetermined period, number of cycles, iterations etc. As shown in FIG. 2 there is defined a surface 240 made up of a series of points 241 corresponding to a dense matrix of values, so that for every combination of a set of defined, regularly spaced X and Y axis values there is a likelihood of error value. The intervals between X axis values and Y axis values may be chosen to correspond to the granularity of measurements from operating system or other system monitoring software applications, so that the monitoring software's output can be directly mapped to a likelihood of error value. The intervals between X axis values and Y axis values may be chosen to be much smaller that the granularity of measurements from operating system or other system monitoring software applications, so that for any for any output from the monitoring software there will be a x-y combination that is only a very short distance from the measured value, which can be used directly to provide a close approximation of a likelihood of error value. An advantage of this approach is that it is not dependant on a particular operating system or monitoring software, so that the model can be used across a wide range of different environments. The intervals between X axis values and Y axis values may be chosen at any convenient value, for example such that the z axis value between any two adjacent points does not change by more than a predetermined margin. Where measurements from operating system or other system monitoring software applications fall between a number of x-y value combinations, an interpolation may be carried out of nearby points to as to estimate a value for the measured values. According to certain embodiments, rather than storing the surface as a set of points, the shape of the whole surface may be interpolated to as to derive a function describing the surface in its entirety, from which a likelihood of error value for any x-y combination may be derived as required. An advantage of this approach is that it may require less storage space.

FIG. 3 Shows a further example of performance model in the form of a multi-dimensional space 300. The X axis 210 and Y axis 220 and z Axis 230 correspond to those described with reference to FIG. 2. As shown in FIG. 3 there is defined a surface 340 made up of a series of points 341 corresponding to a sparse matrix of values, so that for selected combinations of X and Y axis values there is a likelihood of error value. Generally the performance model according to the embodiment of FIG. 2 will contain less data for a similar amount of information, or more information for an equivalent amount of data, in comparison to the approach of FIG. 2. The distance between each point may be chosen to be much smaller that the granularity of measurements from operating system or other system monitoring software applications, so that for any for any output from the monitoring software there will be a x-y combination that is only a very short distance from the measured value, which can be used directly to provide a close approximation of a likelihood of error value. An advantage of this approach is that it is not dependant on a particular operating system or monitoring software, so that the model can be used across a wide range of different environments. The distance between X axis values and Y axis values may be chosen at any convenient value, for example such that the z axis value between any two adjacent points does not change by more than a predetermined margin. Where measurements from operating system or other system monitoring software applications fall between a number of x-y value combinations, an interpolation may be carried out of nearby points to as to estimate a value for the measured values. According to certain embodiments, rather than storing the surface as a set of points, the shape of the whole surface may be interpolated to as to derive a function describing the surface in its entirety, from which a likelihood of error value for any x-y

While FIGS. 2 and 3 show a three dimensional surface representing the likelihood of error for combinations of two system condition variables, it will be appreciated that all aspects of the foregoing discussion are scalable to any number of system condition variables, that is, a space have more than three dimensions. The model may thus contains a plurality of different sets of performance values, each set relating to some or all of said measurements. The predetermined system resources may comprise at least one of available system cpu capacity, available system memory, available system disk or available network sockets.

As described above with reference to FIGS. 2 and 3, there may be provided a step of determining whether the performance model comprises a performance value corresponding exactly to said measurements, and in a case where the performance model does not comprise a performance value corresponding exactly to said measurements, extracting one or more neighbouring performance values from said performance model corresponding respectively to one or more closest available measurement values. Alternatively, the may be provided the further step of interpolating a performance value from said neighbouring performance values.

An important advantage is that “performance models” can be a formal and scientific (thus comparable among applications and systems) documentation for an application's behavioral aspects beyond their usual functional aspects. This shift opens an enormous number of possible areas of application of this disclosure.

It will be appreciated that performance models in accordance with the present invention may facilitate the comparison of a capacities of similar products. For this to be practicable, the various products should ideally use a shared definition of the performance statements on which performance is measured and the resource definitions that constitute the axes of the space. This should at least be possible across different releases of the same products, and may even be possible for different brands.

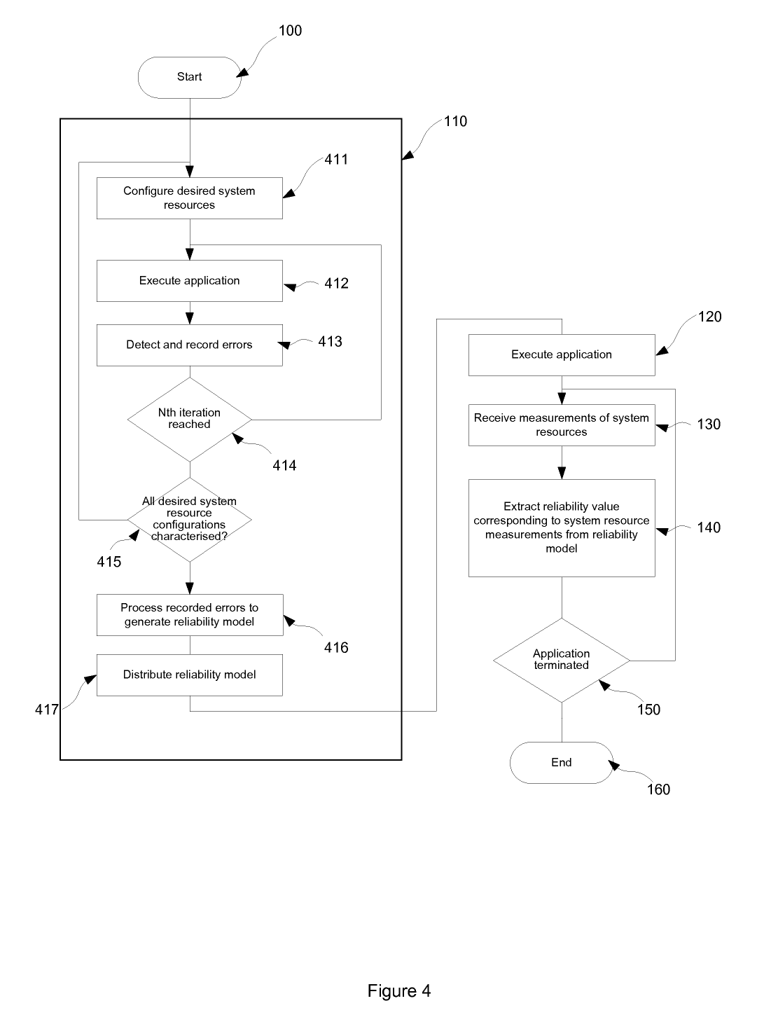

FIG. 4 shows the steps of a second embodiment of the present invention. The process of FIG. 4 is the same as that as FIG. 3, but details certain exemplary sub-steps of the step 110 of providing a performance model. More specifically, FIG. 4 shows one possible method of creating such a performance model. As shown, the process defined in the substep 110 starts at step 411, whereby the resources of a test system are configured for the purposes of a test execution. As discussed above, this may be implemented in many ways depending on the nature of the test system itself, for example by suitably configuring a virtual machine, application server etc. The process next proceeds to step 413 during which the application is monitored and any errors recorded. Once the application has been run to termination, or through a predefined test sequences, or for a predefined period of time, the process proceeds to step 415, at which it is considered whether the application has been executed under each of the different test system configurations necessary to compile the performance model. If it has not, then the process returns to step 411 at which the test system is set to the next required configuration, so that the process loops though each required configuration in turn. If the application has been executed under each of the different test system configurations necessary to compile the performance model, the process proceeds to step 416, at which the errors recorded by each iteration of step 415 are processed together with the system configurations in force for each respective error to compile the performance model as discussed above. One the performance model has been duly compiled, it may be distributed to user of the application, either together with a copy of the application, or otherwise, whereupon the process resumes at step 120 as described above.

The performance model computation is preferably generated by executing a high number of tests automatically (leveraging test automation techniques widely available in the development teams) by means of iteratively varying the resources made available by an Application Server, to each application and tracking “performance” of that point by simply accounting the successful tests passed in that point (that is execution test passed some quality criterion).

As an alternative to application servers the same procedure can be applied in every hosting environment where resources dedicated to applications can be programmatically set or controlled.

This procedure will derive a picture of the behavior of the application in various operating condition.

According to a further development of the steps of FIG. 4, or otherwise, the following steps may be implemented to define the performance model:

1) Identify a list of test cases to cover application functionalities

2) Identify a list of logical resources to consider, examples: unit of cpu, memory, disk, sockets etc. . . .

3) Identify a list of quality definitions: “problems” are defined as quality measure not satisfied (certain keyword met in system or application log, performance results from internal/external monitoring, performance instrumentation etc). At least this definition can match what can be monitored with commercial monitoring software in the commercial platform (details could provided enumerating software packages and platforms).

4) Identify and codify how logical resources are bound to physical and operating system resources (could be 1 to 1 in the simplistic case), this is to better interoperate with monitoring software, the best is to compute the performance measures based on a set of measurements directly available from commercial resource monitoring packages in their native format. The application could expose several matrices (for different platforms for example, or for different monitoring software supported) for one kind of “failure/problem” predicted

5) Consider each resource as an axis of a multi dimensional space r(1 . . . NR). Each cell start with 0.

6) Select a number of sampling points on each axis of the multi- dimensional at a certain level of granularity and represent the sampled space with an NR-dimensional sparse matrix of integers values Failure_{—Space[i}1][i2] . . . [iNR]

7) Compile a list of the resulting test points, where each point originates from a single test case from step 1) and is obtained by a monte-carlo variation of the application input parameters for the each given single test scenario.

8) Execute each resulting test point compiled at step 7) for all the sampling points selected at step 6) each time varying the resources available to the application (resource context vector) according to the resource vector identified by the sampling point and collect results (failures or not): each failure/problem results increment the value in the corresponding matrix cell (that starts from 0). Repeat the process for each test case at point 1)

9) Estimate the resulting failure model parameters that is for each point of the “failures space” estimate the probability to get a failure according to the following procedure: incrementally sum (starting from 0) the number of failures/critical condition/bugs occurred when each test case was run in a certain resources condition (resource context) in the cell of the Failure_{—space[i}1][i2] . . . [iN] that represents that resource context of test case execution.

The resulting performance model is preferably populated prior to distribution, and the performance model is distributed with the software, for example by being packaged in an archive to be deployed along with the application it refers to. Alternatively the model may be distributed by a separate channel, for example through download via a network etc.

The performance model is then used at execution time for example together with a resource monitoring or resource prediction (by means of historical data) software.

The execution environment loads the application and retrieves its reliability model, a set of computing resources of the execution environment is specified as to be predicted/monitored by a selected resource prediction/monitoring software

The predicted/monitored set of resources is then used to assemble a vector of values that correspond to a point in a resource space, which can be used as a resource context vector. The resource manager accesses the reliability model and retrieves the reliability value available a the point identified by the resource context vector by reading the value in the model or interpolating from available nearest points in the model.

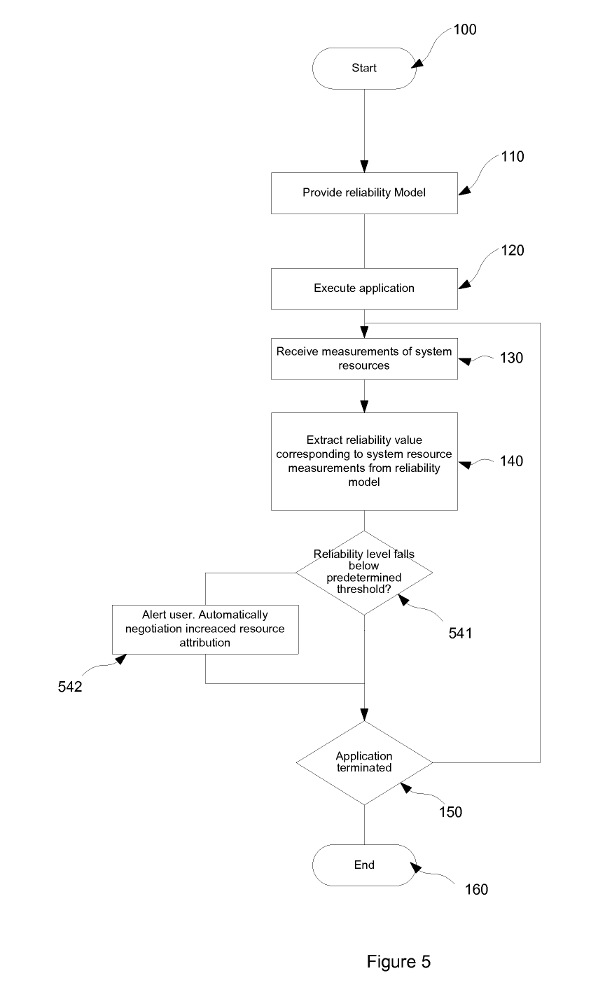

FIG. 5 shows the steps of a third embodiment of the present invention. The process of FIG. 5 is the same as that as FIG. 3, but details certain further steps between steps 140 and 150. More specifically, FIG. 5 shows one way of using the performance value extracted from the performance model at step 140. As shown, rather than proceeding directly to step 150 after step 140 the process proceeds to step 541, at which it is determined whether the performance value extracted at step 140 falls below a predetermined threshold or not. In accordance with present embodiment, this predetermined threshold represents an acceptable performance level. This threshold may be a value specifically associated with the application, a particular user account, a particular machine, the time of day at which the application is executed, etc. There may be defined a hierarchy of applications, whereby the threshold for a particular application is defined by its position in that hierarchy, such that more important or urgent applications are considered to be less tolerant of errors, so that a lower threshold is set for these applications. If the performance level is found to be above the threshold, indicating the according to the performance model the application should perform satisfactorily under the present operating conditions, the process proceeds to step 150 as described above. If on the other hand the performance level is found to be below or equal to the threshold, indicating the according to the performance model the application should perform unsatisfactorily under the present operating conditions, for example in that the likelihood of a crash is above a certain value, the process proceeds to step 542. At step 542, the process executes steps intended to mitigate the problems associated with the expected poor performance of the application. For example, the system may automatically alert a user of the application, a system manager or other individual of the poor expected performance, for example by means of a pop-up window, email, etc. The system may also automatically undertake steps to remediate the situation, by seeking to obtain further resources either by redefining the operating environment itself, or by shutting down less importance applications or processes. Accordingly there are provided the steps of alerting a user when said performance value falls below a predetermined threshold, or attempting to automatically negotiate an increased resource attribution from said system for said software when said performance value falls below a predetermined threshold.

As a further development of the above, it may be imagined that a system may be executing a number of applications associated with performance models in accordance with the present invention. Where this is the case, the system may attempt to attribute system resources to these different applications in such a way as to optimise overall performance.

2) The predicted/monitoring set of resources is then used to assemble a vector of values that corresponds to a point in a resource space, is can be used as a context resource vector:

3) Giving the predicted context resource vector the performance model a probability of failure/problems is obtained for the given context.

4) At this stage the administrator could have fixed a threshold so that if the system exceeds that value then the resource manager can initiates a number of actions to prevent those probable problem, including:

a) notifications to administrators

b) reassigning/augmenting the resources (migration to different cluster nodes) made available to application, for example by interaction with a provisioning system

c) automatically increase the rate of system logging, and/or the variety if information types logged.

According to a further embodiment there is provided a performance or reliability model representing the behaviour of an application under different system resource conditions is provided. This model may take the form of one or more sparse matrix providing a reliability or performance values for different combinations of conditions. This model is distributed to a user of the application, and is consulted during execution of the application with reference to system resource information provided by the operating system or other monitoring software so as to provide a indication of the expected performance of the application under present operating conditions. This indication may be notified to a user, for example in a case where the indication falls outside predetermined bounds of satisfactory operation. The system may also attempt to renegotiate attributed system resources to as to improve performance.

It may be noted that in certain real world applications performance may vary in different operating conditions. According to certain embodiments, test different test scenarios may be designed to test different aspects of software performance. Such scenarios may reproduce common system events such as “register new user to the system”. By the same taken, the performance model may also be structured so as to comprise sub-parts relating respectively to different aspects of software performance, or corresponding to different use scenarios. These aspects and/or use scenarios may advantageously correspond to the aspects/ test scenarios used in the test phase. These aspects may be represented in terms of separate performance spaces. Where the performance model is thus structured, it may be desirable to associate different parts of the performance model with different scenarios by means for example of “tags” that may characterize the scenario, or a subsection of the scenario. One way of thus characterizing a scenario or subsection of a scenario would be in terms of the workload associated therewith, since different workload levels will lead to separate performance “spaces”. As shown in the following table, the performance model contains a performance space corresponding to the system events “register new user to the system”, and performance sub-spaces corresponding to the situation where 1-20 users are connected to the system, and another where 21 to 100 users are connected to the system, on the basis that the system will behave differently under these two loading scenarios.

| | fvi scenario- | Performance | |
|---|---|---|---|
| fvi scenario | characterization | Sub-space | Comment (sample) |
| register | 1-20 users | model 1.A | Is likely the system |
| new user to | connected | | will start work badly |
| the system | to the system | | with less than 100 MB |
| | | | free memory per user |
| register | 21-100 users | model 1.B | Is likely the system |
| new user to | connected | | will start work badly |
| the system | to the system | | with less than 1000 MB |
| | | | free memory |

According to certain embodiments making use of a multiple space performance model as described above, there is provided an input characterization component that listens to the input channels of the application so as to provide a characterization of the current input condition, and from this classification to select the most appropriate multidimensional space that represents the performance behavior.

According to a preferred embodiment each test case is expanded prior to test automation with some technique, e.g. monte-carlo, so as to provide enough samples to compute a statistical distribution in selected cases. In particular the step of testing of the software in systems configured with each of the desired combinations of system resources, preferably involves defining the desired combinations of system resources in a random or pseudo random manner. More preferably, the desired combinations of system resources constituting the desired combinations of test conditions are defined by means of monte-carlo variations of test parameters such as system resource parameters.

Still further, aspects of the test case steps themselves may be defined by means of random, pseudo random or monte-carlo variations of seed cases. For example a general test case may comprise providing input parameters that are given as input to a certain application, such as the ‘Create a new user’ process which calls for parameters such as the first name and family name,

System resources may be varied amongst the various permissible permutations of 16 conditions varying for example 3 available memory points (10 MB 100MB 1000 MB) and 3 available operating points of a CPU unit (10% 50% 90%).

However it will be appreciated that in some cases a single test at a particular combination of parameters may not provide a reliable representation of the behavior of the software. For example, the behavior of the software or more particularly the manner in which it is dependent on the availability of certain resources may depend on the details of the test case itself. For example, in the case of the ‘Create a new user’ process suggested above, it may be that the system may draw differently on system resources depending on the name used in the test case.

Accordingly it may be unsound to draw conclusions on the basis of software behavior measured over a number of repetitions of the same identical test case. It is accordingly proposed to introduce variations in the details of some or all test cases, so as to ensure that each test case properly tests the selected aspect if the softwares resource dependency regardless of the specifics of the data in use.

In the case of the present example, rather than using a fixed user name for the ‘Create a new user’ process, a randomly or pseudo=-randomly generated user name may be generated for each new test case iteration, so that by gathering software performance measurements over a number of iterations any anomalies associated with particular test data can be ruled out.

Thus in the present example the ‘Create a new user’ process may be carried out for example 1000 times, each time using different user creation parameter e.g. taking the name from a name dictionary (randomly) and the family name from a family name dictionary (randomly), If on this basis it is determined that at the selected system resource settings a failure occurs in 900 of 1000 test iterations, a final failure probability of 0.9 can be determined

This process may then be repeated for each further set of parameters as described above. Again, Monte Carlo techniques may be used in the generation of test case data variations.

Specifically, if test cases T1 . . . TN are defined covering all application functionalities, for a given test case T1 in the order of 1000 variations of the data required by T1 may be required depending on the technical context, bearing in mind the fact that if the number of variations possible is constrained by the system itself, then it may be meaningless to seek variations beyond what the system can realize. Accordingly the T1 input parameters are varied to obtain Ti 1 T1 1000 simulated test cases, then T2 1 . . . T2 1000, to TN 1 . . . TN 1000:

If the sampling of the resource space identifies 16 resource conditions e.g. Memory and Disk resources only are considered and in their corresponding axes 4 sampling points.

Each test case variation T1 1 . . . T1 1000 T2 1 . . . T2 1000 TN 1 . . . TN 1000 is then run in 4 different resources contexts Ti 11 . . . T1 1 4 and so on, for each Tx y. The overall execution fills the Failures Space. The number of monte-carlo variations and resource sampling point are to be chosen according to statistical significance considerations.

Thus accordingly the present embodiment the software is executed a plurality of times for a given combination of system resources. Preferably for each execution of said software under a given combination of system resources, different values for the input data required for said execution are defined. Preferably, the different values may be defined in a random manner. Preferably, the different values may be defined in a pseudo-random manner. Preferably, the different values may be defined by means of monte-carlo variations. Such monte-carlo variations may themselves start from a standard or randomly selected seed value.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

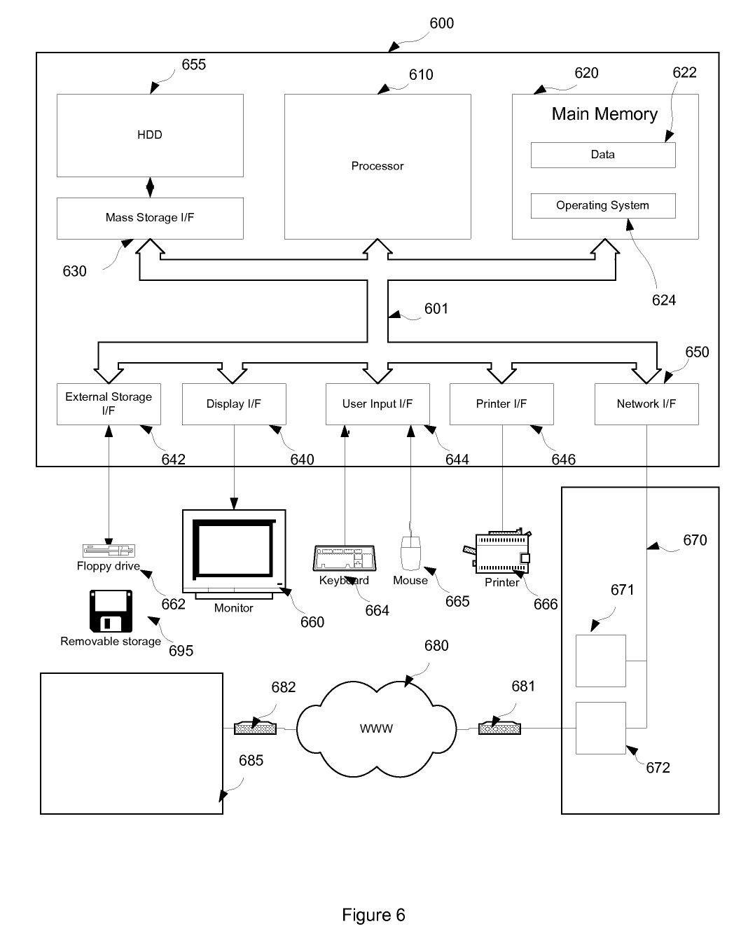

FIG. 6 shows a computer environment suitable for implementing certain embodiments. As shown in FIG. 6, Computer system 600 comprises a processor 610, a main memory 620, a mass storage interface 630, a display interface 640, and a network interface 650. In particular, computer system 600 may be at least partially a virtual machine. Many of the components of the system 600 constitute system resources which may be varied in different combinations during the testing phase as described above. These system components are interconnected through the use of a system bus 601, which has a particular transfer capacity which constitutes an example of a system resource which may be varied in different combinations as described above. Mass storage interface 630 is used to connect mass storage devices (Hard disk drive 655, which constitutes an example of a system resource which may be varied in different combinations as described above) to computer system 600. One specific type of removable storage interface drive 662 is a floppy disk drive which may store data to and read data from a Floppy disk 695, but may other types of computer readable storage medium may be envisaged, such as readable and optionally writable CD ROM drive. There is similarly provided a User input interface 644 which received user interactions from interface devices such as a mouse 665 and a keyboard 664. There is still further provided a printer interface 646 which may send and optionally receive signals to and from a printer 666.

Main memory 620 which constitutes an example of a system resource which may be varied in different combinations as described above in accordance with the preferred embodiments contains data 622, an operating system 624.

Computer system 600 utilises well known virtual addressing mechanisms that allow the programs of computer system 600 to behave as if they only have access to a large, single storage entity instead of access to multiple, smaller storage entities such as main memory 620 and HDD 655 which constitutes an example of a system resource which may be varied in different combinations as described above. Therefore, while data 622, operating system 624, are shown to reside in main memory 620, those skilled in the art will recognize that these items are not necessarily all completely contained in main memory 620 at the same time. It should also be noted that the term “memory” is used herein to generically refer to the entire virtual memory of computer system 600.

Data 622 represents any data that serves as input to or output from any program in computer system 200, and in particular may include the application under test. Operating system 424 is a multitasking operating system known in the industry as OS/400; however, those skilled in the art will appreciate that the spirit and scope of the present invention is not limited to any one operating system.

Processor 610 may be constructed from one or more microprocessors and/or integrated circuits. The capacity of the processor constitutes an example of a system resource which may be varied in different combinations as described above Processor 610 executes program instructions stored in main memory 620. Main memory 620 stores programs and data that processor 610 may access. When computer system 600 starts up, processor 610 initially executes the program instructions that make up operating system 624. Operating system 624 is a sophisticated program that manages the resources of computer system 600. Some of these resources are processor 610, main or system memory 620, mass storage interface 630, display interface 640, network interface 650, and system bus 601.

Although computer system 600 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 610. However, those skilled in the art will appreciate that the present invention applies equally to computer systems that simply use I/O adapters to perform similar functions.

Display interface 640 is used to directly connect one or more displays 660 to computer system 600. These displays 660, which may be non-intelligent (i.e., dumb) terminals or fully programmable workstations, are used to allow system administrators and users to communicate with computer system 600. Note, however, that while display interface 640 is provided to support communication with one or more displays 660, computer system 600 does not necessarily require a display 665, because all needed interaction with users and other processes may occur via network interface 650.

Network interface 650 which constitutes an example of a system resource which may be varied in different combinations as described above is used to connect other computer systems and/or workstations (e.g., 675 in FIG. 6) to computer system 600 across a network 670. The present invention applies equally no matter how computer system 600 may be connected to other computer systems and/or workstations, regardless of whether the network connection 670 is made using present-day analogue and/or digital techniques or via some networking mechanism of the future. In addition, many different network protocols can be used to implement a network. These protocols are specialised computer programs that allow computers to communicate across network 670. TCP/IP (Transmission Control Protocol/Internet Protocol) is an example of a suitable network protocol., for example over an Ethernet network. As shown, the network 670 connects the system 600 to two further devices 671 and 672, which may be other computer systems similar to that described above, or other network capable devices such as printers, routers etc. In the present example, network device 672 is a local server, which is connected via a modem 681 to a public network 680 such as the word wide web. By means of this public network 680 a connection to a remote device or system 685 may be established.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROM (e.g., 695 of FIG. 6), and transmission type media such as digital and analogue communications link

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1-17. (canceled)

18. A method of optimising software execution in a system in which the software is executed, the method comprising:
providing a performance model representing a performance of the software under different selected system conditions as described in terms of one or more predetermined system resources;
receiving a measurement of each of the predetermined system resources for a given moment in time; and
extracting a performance value from the performance model corresponding to the measurements.

19. The method of claim 18, further comprising: populating the performance model by testing the software.

20. The method of claim 19, wherein the testing of the software further comprises repeatedly executing the software in systems configured with at least one combination of selected system resources, and compiling statistical data concerning the application's behaviour under each configuration.

21. The method of claim 20, wherein the software is executed a plurality of times for a given combination of system resources.

22. The method of claim 21, wherein for each execution of the software under a given combination of system resources, different values for input data required for the execution are defined in a random or pseudo-random manner or using monte-carlo variations thereof.

23. The method of claim 20, wherein the systems are virtual machines.

24. The method of claim 19, wherein the model is populated prior to distribution, and where the performance model is distributed with the software.

25. The method of claim 18, further comprising: determining whether the performance model comprises a performance value corresponding exactly to the measurements, and in a case where the performance model does not comprise a performance value corresponding exactly to the measurements, extracting one or more neighbouring performance values from the performance model corresponding respectively to one or more closest available measurement values.

26. The method of claim 25, further comprising: interpolating a performance value from the neighbouring performance values.

27. The method of claim 18, further comprising: alerting a user when the performance value falls below a predetermined threshold.

28. The method of claim 18, further comprising: attempting to automatically negotiate an increased resource attribution from the system for the software when the performance value falls below a predetermined threshold.

29. An apparatus, configured to perform a method of optimising software execution in a system in which the software is executed, the method comprising:
providing a performance model representing a performance of the software under different selected system conditions as described in terms of one or more predetermined system resources;
receiving a measurement of each of the predetermined system resources for a given moment in time; and
extracting a performance value from the performance model corresponding to the measurements.

30. A computer program, encoded on a computer readable storage medium, comprising instructions for performing a method of optimising software execution in a system in which the software is executed when the computer program is executed on a computer, the method comprising:
providing a performance model representing a performance of the software under different selected system conditions as described in terms of one or more predetermined system resources;
receiving a measurement of each of the predetermined system resources for a given moment in time; and
extracting a performance value from the performance model corresponding to the measurements.
